(19) United States
(12) Patent Application Publication
(10) Pub. No.: US 2024/0281647 A1
(43) Pub. Date: Aug. 22, 2024

(54) NEURAL NETWORK CIRCUIT FOR DEEP ARTIFICIAL NEURONAL NETWORKS USING DEEP FEEDBACK CONTROL

(71) Applicant: ETH Zürich, Zürich (CH)

(72) Inventors: Alexander Marc E. Meulemans, Bern (CH); Benjamin Friedrich Grewe, Gockhausen (CH); Matilde Tristany Farinha, Zürich (CH); Javier Garcia Ordonez, Zürich (CH); Joao Rodrigues Sacramento, Thalwil (CH); Pau Aceituno, Zürich (CH)

(73) Assignee: ETH Zürich, Zürich (CH)

(21) Appl. No.: 18/570,029

(22) PCT Filed: Jun. 13, 2022
(86) PCT No.: PCT/IB2022/055458

§ 371 Date: Dec. 13, 2023

(30) Foreign Application Priority Data
Jun. 14, 2021 (EP) 21179208.0

(51) Int. Cl. G06N 3/065; G06N 3/0442

(52) U.S. Cl. CPC G06N 3/065; G06N 3/0442

(57) ABSTRACT

The present invention relates to a time-continuous neural network circuit implemented on analog hardware with device mismatch, the circuit including a control unit (40) which is individually connected to each respective neuron of the circuit, the neurons in the hidden and output layers comprising a forward compartment for processing signals coming from preceding layers, a feedback compartment for processing feedback signals coming from the control unit and a central compartment for generating and sending a signal to the next layer or to the control unit. The control unit generates and sends to the feedback compartment of each respective neuron a feedback signal (S_{f}) based on the comparison between a network output signal (Sₒᵤₜ) and a target signal (Sₜₐᵣ).

The present invention relates to a time-continuous neural network electronic circuit implemented on analog hardware with device mismatch designed for implementing information processing and training of complex neural networks such as deep neural networks.

### RELATED ART

Different kinds of bio-inspired physical (hardware) or virtual (software) neural network circuit are known in the prior art, and aimed at different purposes such as:
Function approximation (which can be viewed as the key for all other applications)
Classification
Tracking
Pattern/object recognition
Speech recognition
Model generation (text, music, images, etc.)
Signal processing
Sorting/searching
Decoding/translation
Etc

Neural networks may be implemented either on digital hardware or on analog hardware. If implemented on digital hardware, neural network operations typically are carried out at discrete and temporally equispaced timepoints, and all values are further quantized. Analog hardware, on the other hand, may allow time-continuous operation of neural networks., i.e., a single neuron's behavior may be modelled using differential equations which can be directly realized using analog components, e.g., analog lumped elements such as networks of capacitors, resistances, and inductors; the neural network may also be implemented as an analog integrated circuit. A drawback of implementing neural networks on analog hardware is possible mismatch: fabrication imperfections may introduce parameter variation of analog components; for example, while a capacitor may be specified as having a capacitance C₁, the fabricated capacitor may have a different capacitance C₂. Neural networks which are implemented on analog hardware may therefore show worse behavior than neural networks implemented on digital hardware in case they are not adapted to analog device mismatch which in general varies from one analog hardware device to the other.

There are multiple types of neural networks, depending on the neuron capabilities and the interconnections schemes. A neuron is usually a simple operator, performing a non-linear function (decision, firing) of weighted inputs.

The connections between neurons define the different types of networks and their applications. The most important types of neural networks in use today are:
DNN: deep neural network, multi-layer feedforward network;
CNN: convolutional neural networks, using differentiated layers for local and global data processing;
RNN: recurrent neural networks, reusing outputs along with inputs in the weighted sum;
generative adversarial networks, autoencoders, deep Q-networks and LSTM networks, Bayesian Networks as well as autoregressive and transformer networks, spiking neural networks;
Etc.

Single or multi-layer DNN can support multiple neuron function implementations. Most common are Perceptron (SLP/MLP) and Radial Basis Functions (RBF). Both have been proven universal function approximators. Beyond implementation details, these models differ by their learning requirements.

While software implementations of neural networks running on Von-Neumann machines are highly flexible, they are also slow and energy inefficient. Conversely, native hardware implementation may improve processing speed through very high parallelism capabilities, local memory usage, and can improve power/processing ratios. In terms of energy efficiency for continuously running on-chip learning systems, the most energy and space efficient option typically is to use analog circuits.

Device mismatch often hinders design of small, energy efficient chips as a real circuit deviates from the original design. This problem becomes more and more prominent as the energy and area of the circuit become smaller, to the point that it is often worse than thermal noise.

Training algorithms known from the prior art for deep neural networks typically require very precise knowledge of circuit nonlinearities and parameters. Backpropagation, for instance, requires precise models of the network that it trains to calculate derivatives. In fact, most calculus-based optimization methods have this requirement. Energy based models, on the other hand, do not require such knowledge, but they require symmetry in the neurons; current must flow equally well in both directions for every node, and this requires neurons that have twice the same circuit in both directions. As it is impossible to make efficient, small and precise circuits, it is unrealistic to expect that those local circuits will have the same circuit in both directions.

Most current network training approaches try to address algorithmic energy as well as memory efficiency shortcomings using discrete time artificial neural networks (ANNs) and standard stochastic gradient backpropagation (SGD-BP). However, because standard learning methods operate in discrete time, they are practically ill posed for addressing the problems described above in particular when it comes to continual learning, memory efficient computing and low energy computing on analog hardware.

The document WO2018081600A1 discloses a neural network circuit in which the neurons include a recognition unit and a generative unit. The recognition units are connected between them, and the generative units are connected between them. A controller is configured to drive the network towards a desired activity. However, this circuit does not allow the controller to provide a feedback simultaneously to each neurons in every hidden layer in the network and the learning phase alternates between a wake phase and a sleep phase, which cause the network to have to run twice.

In PODLASKI William and MACHENS Christian, Biological credit assignment through dynamic inversion of feedforward networks, NeurIPS, 2020, a mathematical model for the inversion of the feedforward network transformations is disclosed. However, the learning of the neural weights is mediated by a dynamic inversion method that converses to the error and thus is in principle similar to backpropagating an error signal.

In ALEMI Alireza et al., Learning arbitrary dynamics in efficient, balanced spiking networks using local plasticity rules, AAAI, 2018, a mathematical model for the dynamical control or recurrent neural networks, however the learning method is limited to neural networks having a single hidden layer and is therefore not suited for deep neural networks.

In MEULEMANS Alexander et al., A theoretical framework for target propagation, Advances in Neural Information Processing Systems, 2020, a target propagation-like method is disclosed. The method combines elements of standard target propagation and elements of Gauss-Newton optimization. However, this method does not involve any controller as a feedback can be provided to the neurons in the hidden layers, but directly from the output layer.

In BENGIO Yoshua, Deriving differential target propagation from iterating approximate inverses, arXiv preprint arXiv:2007.15139, 2020, a target propagation-like method is disclosed. This method also combines elements of standard target propagation and Gauss-Newton optimization. However, this method is limited to invertible networks, hence networks with the same layer size for all layers and invertible nonlinearities.

There is therefore a need for neural network circuits implemented on analog hardware capable of combining energy efficiency and robust training of complex neural networks, in particular deep neural networks having an arbitrary number of hidden layers of variable size.

### SHORT DISCLOSURE OF THE INVENTION

An aim of the present invention is the provision of a neural network circuit that overcomes the shortcomings and limitations of the state of the art.

Another aim of the invention is to provide a neural network circuit that is energy efficient and allows the implementation and the training of complex neural networks such as deep neural networks having an arbitrary number of hidden layers of variable size.

According to the invention, these aims are achieved by means of a time-continuous neural network electronic circuit implemented on analog hardware with device mismatch, comprising, an input layer, at least one hidden layer, wherein a first hidden layer of the at least one hidden layer is operatively connected to the input layer, an output layer, wherein the output layer is operatively connected to a hidden layer of the at least one hidden layer, a first control unit operably connected to the at least one hidden layer and the output layer; and wherein the at least one hidden layer comprises a plurality of neurons for processing at least one first signal (S₁) which the first hidden layer is configured to receive from the input layer; and wherein the output layer comprises at least one output neuron for processing at least one second signal (S₂) which the output layer is configured to receive from the at least one hidden layer. Each respective neuron in the hidden layer comprises: (i) a first forward compartment configured for receiving and processing, in a first forward computing unit which first forward computing unit is comprised by the circuit, a) the first signal (S₁) received from the input layer in case of a neuron in the first hidden layer or b) a second signal of the at least one second signal (S₂) received from a hidden layer of the at least one hidden layer in case of a neuron in a hidden layer different from the first hidden layer, and for generating a third signal (S₃) based on the first signal (S₁) or based on the second signal and based on an associated first set of forward weights (W₁) stored in a first forward memory unit which first forward memory unit is comprised by the circuit, (ii) a first feedback compartment configured for receiving and processing, in a first feedback computing unit which first feedback computing unit is comprised by the circuit, a feedback signal (S_{f}) received from the first control unit, and for generating a fourth signal (S₄) based on the feedback signal (S_{f}) and based on an associated first set of feedback weights (Q₁) stored in a first feedback memory unit which first feedback memory unit is comprised by the circuit, (iii) a first central compartment connected to said first forward and first feedback compartments and configured for receiving and processing, in a first central computing unit which first central computing unit is comprised by the circuit, the third signal (S₃) from the first forward compartment and the fourth signal (S₄) from the first feedback compartment, and configured to generate a second signal (S₂) based on the third and fourth signals (S₃ S₄). Each output neuron in the output layer comprises: (iv) a second forward compartment configured for receiving and processing, in a second forward computing unit which second forward computing unit is comprised by the circuit, a second signal (S₂) of the at least one second signal from a neuron in the at least one hidden layer, and for generating a fifth signal (S₅) based on the second signal (S₂) and based on an associated second set of forward weights (W₂) stored in a second forward memory unit which second forward memory unit is comprised by the circuit, (v) a second feedback compartment configured for receiving and processing, in a second feedback computing unit which second feedback computing unit is comprised by the circuit, the feedback signal (S_{f}), and for generating a sixth signal (S₆) based on the feedback signal and based on an associated second set of feedback weights (Q₂) stored in a second feedback memory unit which second feedback memory is comprised by the circuit, (vi) a second central compartment connected to said second forward and second feedback compartments and configured for receiving and processing, in a second central computing unit which second central computing unit is comprised by the circuit, the fifth signal (S₅) from the second forward compartment and the sixth signal (S₆) from the second feedback compartment, and configured to generate a seventh signal (S₇) based on the fifth and sixth signals. The first control unit is connected to the output layer and configured to receive a network output signal (Sₒᵤₜ) from the output layer, based on the seventh signals (S₇) of the second central compartment of the output neuron (31), and wherein said first control unit is further individually connected to the first feedback compartment of each respective neuron in the hidden layer and to the second feedback compartment of the output neuron in the output layer and is configured to generate the feedback signal (S_{f}) based on a comparison between said network output signal (Sₒᵤₜ) and a stored target signal (Sₜₐᵣ).

A layer is operatively connected to another layer if said layers are connected in any suitable way that will allow a signal to be passed from one layer to the other. On analog hardware, neurons in different layers may be connected to one another by dedicated wires, for example.

The first forward computing unit can be configured to update the first set of forward weights (W₁) based on the first, the second and the third signal (S₁,S₂,S₃), and wherein the second forward computing unit can be configured to update the second set of forward weights (W₂) based on the second, the fifth and the seventh signal (S₂,S₅,S₇).

The first feedback computing unit can be configured to update the first set of feedback weights (Q₁) based on an approximation of an inverse of a function of the first set of forward weights (W₁) and based on the feedback signal (S_{f}), and wherein the second feedback computing unit can be configured to update the second set of feedback weights (Q₂) based on an approximation of an inverse of a function of the second set of forward weights (W₂) and based on the feedback signal (S_{f}).

The first control unit can be a proportional and/or integrative and/or derivative controller.

The first control unit can be a neural network proportional and/or integrative and/or derivative controller.

The circuit can further comprise a second control unit individually connected to each respective neuron in the at least one hidden layer and to each output neuron in the output layer, the second control unit being configured to generate and send a control signal to the at least one neuron in the at least one hidden layer and to the at least one output neuron in the output layer so as to modify activation parameters of the neural network.

The control signal can be generated based on the second signal (S2) generated by the first central computing unit of the at least one neuron in the at least one hidden layer and/or based on the seventh signal (S7) generated by the second central computing unit of the at least one output neuron.

The second control unit can be a proportional and/or integrative and/or derivative controller.

The circuit can comprise ‘n’ hidden layers, wherein ‘n’ is greater than two, and wherein the ‘n’ hidden layers are connected consecutively, and wherein the first hidden layer is operably connected to the input layer, and the ‘n^{th}’ hidden layer is operably connected to the output layer.

### SHORT DESCRIPTION OF THE DRAWINGS

Exemplar embodiments of the invention are disclosed in the description and illustrated by the drawings in which:

FIG. 1 illustrates schematically a neural network circuit with three layers of neurons and a control unit.

FIG. 2a illustrates schematically a neuron of a hidden layer with three compartments.

FIG. 2b illustrates schematically a neuron of the output layer with three compartments.

FIG. 3 illustrates schematically a neural network circuit comprising neurons with three compartments.

FIG. 4a illustrates schematically a neuron of a hidden layer processing an incoming signal.

FIG. 4b illustrates schematically a neuron of the output layer processing an incoming signal.

FIG. 5 illustrates schematically a neural network circuit with three layer of neurons and a control unit.

### EXAMPLES OF EMBODIMENTS OF THE PRESENT INVENTION

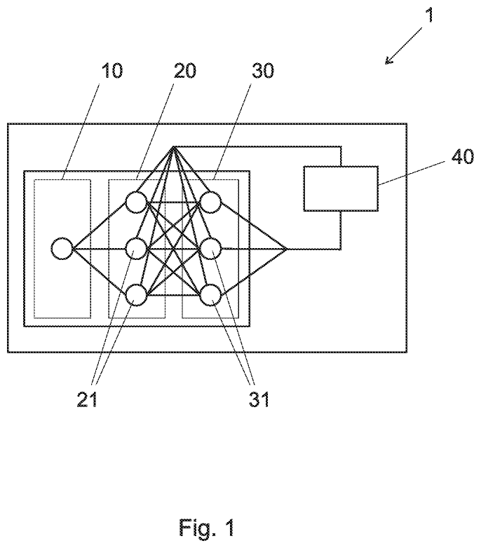

FIG. 1 illustrates schematically a neural network electronic circuit comprising a neural core composed of several layers of neurons and comprising a first control unit. In particular, the neural core comprises an input layer, at least one hidden layer and an output layer, each layer being composed of one or more neurons. The output layer is electrically connected to the first control unit, which is itself electrically connected individually to each respective neuron in the hidden and output layers.

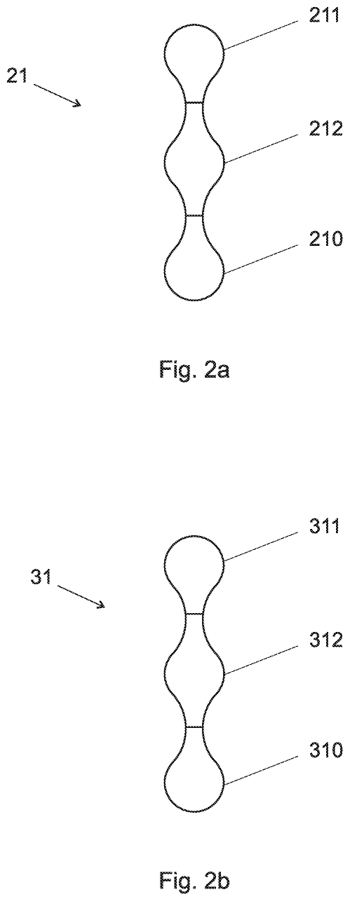

As illustrated in FIG. 2a, each respective neuron 21 in the hidden layer(s) 20 has a particular tri-compartmented structure that comprises a first forward compartment 210, a first feedback compartment 211, and a first central compartment 212. Both the first forward and the first feedback compartment are connected to the first central compartment so as to allow the transmission of electric signals from the first forward and first feedback compartments to the first central compartment of the same neuron. The first forward compartment 210 can be electrically connected to the input layer 10 if the neuron belongs to the first hidden layer or to the first central compartment 212 of a preceding neuron in the preceding hidden layer if there are more than one hidden layer and if the neuron belongs to a hidden layer which is not the first hidden layer of the network. Moreover, the first central compartment 212 is electrically connected to one or more neurons in the next layer so as to be able to transmit electric signals to at least one neuron that belongs to a next hidden layer or to the output layer. In addition to those connections between different layers, the first central compartment 212 of a neuron 21 can be electrically connected to the first forward compartment 210 of the same neuron, or the first forward compartment of a neuron in the same hidden layer.

For the sake of clarity, neurons belonging to the output layer 30 will be referred to as output neurons 31 although their structure does not differ from the structure of the neuron 21 in the hidden layer(s).

Indeed, as represented in FIG. 2b, output neurons 31 in the output layer 30 share the same tri-compartmented structure as the neurons 21 in the hidden layer(s). In particular, an output neuron 31 comprises a second forward compartment 310, a second feedback compartment 311, and a second central compartment 312. Both the second forward and the second feedback compartment are connected to the second central compartment so as to allow the transmission of electric signals from the second forward and second feedback compartments to the second central compartment of the same output neuron. The second forward compartment 310 can be electrically connected to the first central compartment 212 of at least one neuron in the preceding layer which is a hidden layer 20 of the network. In addition to these inter-layer connection, the second forward compartment can also be connected to the second central compartment of the same output neuron or to the second central compartment of a different output neuron in the output layer 30. Moreover, the second central compartment 312 of an output neuron 31 is electrically connected to the first control unit 40 so as to be able to transmit output electric signals from the output neuron to the first control unit 40.

The first control unit 40 is connected to the output layer 30 so as to be able to receive and process electric output signals generated by output neurons in the output layer. The first control unit is also individually connected to each neuron 21 in the hidden layer(s) and each output neuron 31 in the output layer so as to send an electric feedback signal St. More precisely, the first control unit 40 is individually connected to the first feedback compartment 211 of each respective neuron in the hidden layer(s) and to each second feedback compartment 311 of each respective output neuron in the output layer.

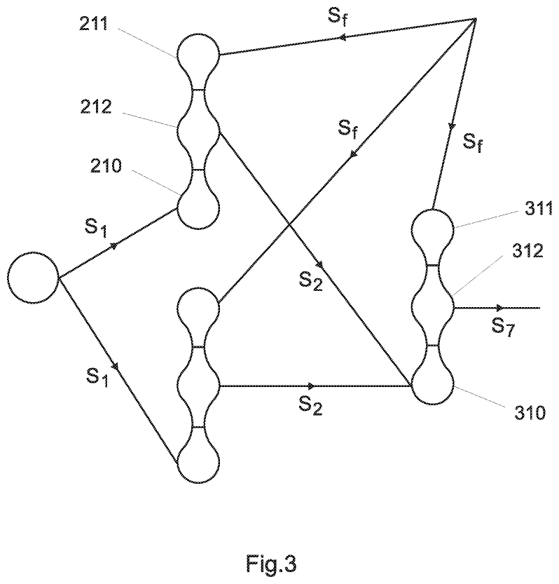

In a particular embodiment illustrated in FIG. 3, the input layer can comprise one input neuron, the hidden layer can comprise a plurality of neurons 21 and the output layer can comprise at least one output neuron 31. The first forward compartments 210 of the two neurons 21 in the hidden layer are connected to the input neuron in the input layer, the first central compartments 212 of these neurons are connected to the second forward compartment 310 of the output neuron 31 in the output layer, and the second central compartment 312 of the output neuron is connected to the first control unit 40. Moreover, the first control unit is connected to the first feedback compartments 211 of the two neurons in the hidden layer and to the second feedback compartment 311 of the output neuron.

Neurons in the input layer 10 are not required to share the same compartmented structure as no processing is operated in those neurons. They are simply connected to at least one first forward compartment 210 of a neuron 21 in the next layer (which is the first hidden layer) so as to transmit the first signal S₁.

In a particular embodiment represented in FIG. 3, the neural network circuit comprises exactly one hidden layer. In this case, the first forward compartment 210 of a neuron in the hidden layer is configured to receive and process a first electric signal S₁ from at least one neuron in the input layer and to generate a third signal S₃ that is based on the first signal and a first set of forward weights W₁. A first forward activation function (preferably a nonlinear activation function) can further be applied to generate the third signal S₃.

The third signal S₃ is generated by a first forward computing unit 2100 that computes a weighted sum of the first signal S₁ and the first set of forward weights W₁, and that applies a first forward activation function (or non-linearity) to the weighted sum. The first set of forward weights W₁ and the parameters of the first forward activation function are stored in a first forward memory unit 2101.

The first forward computing unit 2100 and the first forward memory unit 2101 are embodied as analog hardware.

The first forward computing unit 2100 can be integrated with the neuron itself, for example in the case of certain analog computing units.

Similarly, the first forward memory unit 2101 can be integrated within the neuron itself and/or can comprise on- or off-chip memory blocks. These memory blocks can be distributed so as to minimize the computing time of the first forward computing unit 2100 or regrouped in a single memory block for design reasons.

In a particular embodiment, the first forward computing unit 2100 is integrated within each first forward compartment 210 of the respective neuron and processes the received analog signals. For example, devices such as charge-trapping transistors (CTTs) may be used for processing the signals without any analog-to-digital conversion of the different signals. Such devices may even be used as analog memory units so that the first forward memory units 2101 can be integrated within the first forward compartment of each neuron.

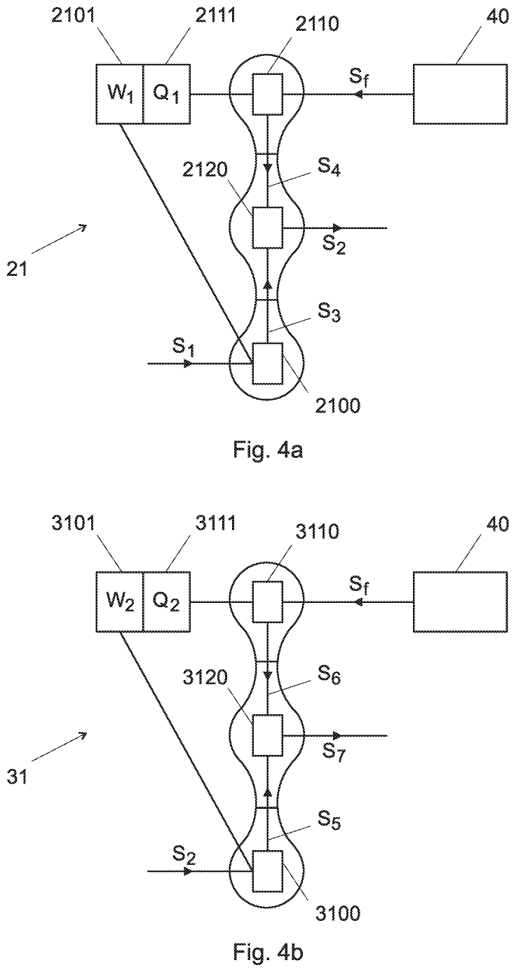

In an embodiment illustrated in FIG. 4a, the first forward computing unit 2100 is integrated within the first forward compartment 210 of the neuron 21. The first set of forward weights W₁ is stored in a first forward memory unit 2101 that is external to the neuron and electrically connected to the first forward computing unit.

As illustrated in FIG. 4a, the third signal S₃ is then sent from the first forward compartment 210 to the first central compartment 212 of the neuron 21. In addition to this third signal S₃, the first central compartment also receives a fourth signal S₄ generated by the first feedback compartment 211 of the same neuron.

The first feedback compartment 211 is designed to receive a feedback directly from the first control unit 40, without backpropagation of a signal through all layers of the network. The first feedback compartment is electrically connected to the first central compartment of the neuron and to the first control unit so as to be able to receive a feedback signal S_{f} from the first control unit.

As in the case of the first forward compartment 210, the first feedback compartment 211 is arranged to process the feedback signal S_{f} in a first feedback computing unit 2110 that computes a weighted sum of the feedback signal S_{f} with a first set of feedback weights Q₁ stored in a first feedback memory unit 2111. The fourth signal S₄ is then generated from this weighted sum and may include applying a linear or non-linear activation function that can be identical or not to the non-linearity that can be applied in the first forward compartment. The parameters of this non-linearity can be stored in the first feedback memory unit 2111.

As described before in the case of the first forward compartment, the first feedback unit and/or the first feedback memory unit are analog components. They may be integrated within the neuron, for example, using charge-trapping transistors or distributed over the chip according to the specific needs of the circuit. All other embodiments and examples described above concerning the first forward processing and memory units 2100,2101 apply in the case of the first feedback processing and memory units 2110,2111.

The fourth signal S₄ is then sent to the first central compartment 212. Once the first central compartment has received the third signal S₃ and the fourth signal S₄, a first central computing unit 2120 generates a second signal S₂ based on the third and fourth signals (S₃,S₄) and sends this second signal to at least one neuron in the next layer. The generation of the second signal S₂ may include applying a linear or non-linear activation function.

In one embodiment represented in FIG. 3, the first central compartments 212 of the neurons 21 in the hidden layer send the second signal S2 to a second forward compartment 310 of an output neuron 31 in the output layer.

More generally, if the neural network comprises at least two hidden layers, the first central compartments 212 of a neuron in a hidden layer can send the signal S₂ either to the first forward compartment 210 of a neuron in a next hidden layer if the next layer is a hidden layer or to the second forward compartment of an output neuron if the next layer is the output layer.

The first central compartments 212 of a neuron in a hidden layer may also send the signal S₂ to the first forward compartment 210 of the same neuron or of another neuron in the same layer.

The structure and the operation of the output neurons 31 in the output layer 30 is identical to those of neurons 21 in a hidden layer 20 apart from the fact that the preceding layer is always a hidden layer and that their signal output can only be sent either to an output neuron in the output layer or to the first control unit 40 since there is no succeeding layer.

As illustrated in FIG. 4b, the second forward compartment 310 of an output neuron 31 is designed to receive from a neuron in the previous layer (which is a hidden layer) the second signal S₂ and to process this second signal in the second forward computing unit 3100. The second forward compartment 310 is also further designed to generate, in the second forward computing unit 3100, a fifth signal S₅ that is based on the second signal S₂ and on a second set of forward weights W₂. A second forward activation function (preferably a nonlinear activation function) can further be applied to generate the fifth signal S₅.

The fifth signal S₅ is generated by the second forward computing unit 3100 which computes a weighted sum of the second signal S₂ and the second set of forward weights W₂, and which applies a second forward activation function (or non-linearity) to the weighted sum. The second set of forward weights W₂ and the parameters of the second forward activation function are stored in a second forward memory unit 3101.

Similarly to the neurons in the hidden layers, the second forward computing unit 3100 as well as the second forward memory unit 3101 are embodied as analog components.

The second forward computing unit 3100 can be integrated with the output neuron itself, for example in the case of certain analog computing units.

Similarly, the second forward memory unit 3101 can be integrated within the output neuron 31 itself and/or can comprise on- or off-chip memory blocks. These memory blocks can be distributed so as to minimize the computing time of the second forward computing unit 3100 or regrouped in a single memory block for physical design reasons.

In a particular embodiment, the second forward computing unit 3100 is integrated within each second forward compartment 310 of the respective output neuron and processes the received analog signals. For example, devices such as charge-trapping transistors (CTTs) may be used for processing the signals without any analog-to-digital conversion of the different signals. Such devices may even be used as analog memory units so that the second forward memory units 3101 can be integrated within the second forward compartment of each output neuron.

In an embodiment illustrated in FIG. 4b, the second forward computing unit 3100 is integrated within the second forward compartment 310 of the output neuron 31. The second set of forward weights W₂ is stored in a second forward memory unit 3101 that is external to the output neuron and electrically connected to the second forward computing unit.

As illustrated in FIG. 4b, the fifth signal S₅ is then sent from the second forward compartment 310 to the second central compartment 312 of the neuron 31. In addition to this fifth signal S₅, the second central compartment also receives a sixth signal S₆ generated by the second feedback compartment 311 of the same output neuron.

As in the case of neurons in the hidden layer(s), the second feedback compartment 311 of an output neuron 31 is electrically connected to the second central compartment 312 of the output neuron and to the first control unit 40 so as to be able to receive a feedback signal S_{f} from the first control unit.

As in the case of the second forward compartment 310, the second feedback compartment 311 is arranged to process the feedback signal S_{f} in a second feedback computing unit 3110 that computes a weighted sum of the feedback signal S_{f} with a second set of feedback weights Q₂ stored in a second feedback memory unit 3111. The sixth signal S₆ is then generated from this weighted sum by further applying a non-linearity that can be identical or not to the non-linearity applied in the second forward compartment 310. The parameters of this non-linearity can be stored in the second feedback memory unit 3111.

As described before in the case of the second forward compartment 310, the second feedback computing unit 3100 and/or the second feedback memory 3110 unit are embodied as analog components. They may be integrated within the output neuron, for example, using charge-trapping transistors or distributed over the chip according to the specific needs of the circuit. All other embodiments and examples described above concerning the second forward processing and memory units 3100,3101 apply in the case of the second feedback processing and memory units 3110,3111.

The sixth signal S₆ is then sent to the second central compartment 312. Once the second central compartment 312 has received the fifth signal S₅ and the sixth signal S₆, a second central computing unit 3120 generates a seventh signal S₇ based on the fifth and sixth signals (S₅,S₆) and sends this seventh signal to the first control unit 40. The generation of the seventh signal S₇ may include applying a linear or non-linear activation function.

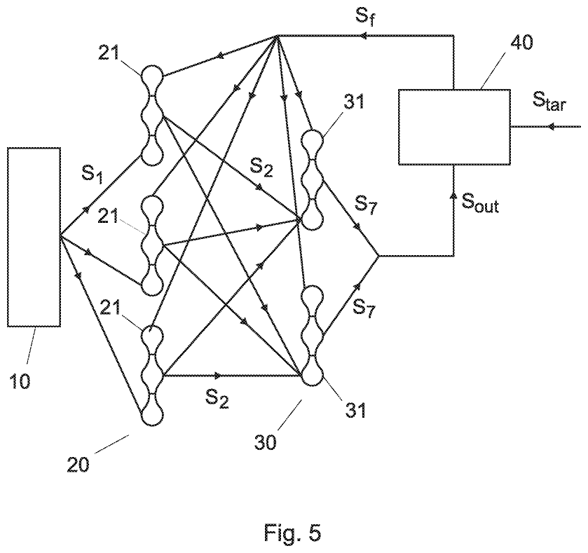

In one embodiment illustrated in FIG. 5, the neural network circuit comprises a plurality of output neurons 31 in the output layer 30. The seventh signals S₇ generated by the second central compartments 312 of the output neurons in the output layer are used to generate a network output signal Sₒᵤₜ that is sent to the control unit 40. The network output signal Sₒᵤₜ can consist of all the seventh signals concatenated into one longer signal.

On a more abstract point of view, one can think of the first (resp. second) feedback compartment of a neuron as an integrated proportional/integral controller that updates the first (resp. second) sets of forward and feedback weights (W₁,Q₁) (resp. (W₂,Q₂)) until the difference between the second signal S₂ (resp. seventh signal S₇) and the third signal S₃ (resp. fifth signal S₅) is driven to zero, or, in other words, until the contribution of the feedback signal St to the first (resp. second) set of feedback weights is reduced to zero. This integrated neuron controller can also be enhanced with differential control.

As illustrated in FIG. 5, the output layer 30 is connected to a control unit 40 whose purpose is to train the neural network by providing a feedback signal S_{f} to the network reflecting whether the output signal Sₒᵤₜ corresponds to a desired target output or not. The first control unit is individually connected through to each neuron in the hidden layer(s) and to each output neuron in the output layer so that the feedback signal St is sent simultaneously to all those neurons, allowing a dynamic feedback to the network. More precisely, the first control unit 40 is electrically connected to the first feedback compartment 211 of each respective neuron 21 in the hidden layer(s) and to the second feedback compartment 311 of each output neuron 31 in the output layer. Learning therefore takes place locally on the analog hardware and is therefore able to accommodate device mismatch of the analog hardware.

While the circuit comprising the neurons and their connections can be made energy efficient, small and have mismatch, the first control unit 40 can be internal (on chip) but also external and contain more costly circuitry that learns a parametrization of the neural core circuits. Since the first and second feedback weights (W₁,W₂) are learned autonomously and locally, they do not require a precise model of the neural core circuit, hence device mismatch is tolerated.

The first control unit 40 is configured to receive the network output signal Sₒᵤₜ and to compare it to a stored target signal Sₜₐᵣ which can be stored in the first control unit itself or in an external memory unit. The first control unit then generates a feedback signal S_{f} based on an error function of the network output signal Sₒᵤₜ and the target output signal Sₜₐᵣ, and which is then sent to the first and second feedback compartments of each neuron in the hidden layer(s) and each output neuron in the output layer. The error function can be, for example, the difference between the network signal output Sₒᵤₜ and the target signal Sₜₐᵣ.

In a particular embodiment, the first control unit 40 can be implemented, for example, by a hardware proportional and/or integrative and/or derivative controller (PID controller). Preferably, the controller is a proportional and integrative controller (PI controller). Such a PI controller computes the difference between the network output signal Sₒᵤₜ and the target signal Sₜₐᵣ and generates the feedback signal S_{f} based on the magnitude of this difference (proportional) and based on the average of this difference over a period of time (integrative).

The PID controller may additionally comprise an auxiliary hardware neural network (NNPID controller) for solving non-linear control problems and computing the feedback signal S_{f}.

If the first control unit 40 determines that the error function between the network output signal Sₒᵤₜ and the target signal Sₜₐᵣ is zero, or in other word if the network output signal coincides with the target signal, for example by crossing pre-determined programmable threshold, then the first control unit continues to operate and to generate the feedback signal S_{f} until all first and second forward/feedback sets of weights (W₁,Q₁,W₂,Q₂) are learned. Once all weights are learned and the error function is zero, the first control unit stops to generate the feedback signal.

When the neural network circuit is not in a learning phase, the first control unit 40 does not engage as no adaptation of the different weights is needed.

One can think of the first control unit 40 as performing a dynamical inversion of the target signal Sₜₐᵣ towards the hidden layer(s), as it dynamically changes the activation of the hidden layer(s) until the network output signal Sₒᵤₜ coincides with the output target signal Sₜₐᵣ.

As for traditional neural networks, the training of the neural network circuit lies in the updating of the different neural weights i.e. in the present case, in the updating of the first and second sets of forward and feedback weights (W₁,Q₁,W₂,Q₂). These sets can be updated in the first and second forward/feedback memory units (2101,2111,3101,3111) by the first and second forward/feedback computing units (2100,2110,3100,3110) according to different learning rules.

The first (resp. second) set of forward weights W₁ (resp. W₂) can be updated according to an error or delta rule using the difference between the actual firing rate of the first (resp. second) central compartment of the neuron (resp. output neuron) which is based on the third and fourth signals (S₃,S₄) (resp. the fifth and sixth signals (S₅,S₆)), and the firing rate of the first (resp. second) forward compartment based on the first signal S₁ (the second signal S₂). In this case, the first and second forward weights (W₁,W₂) are learned locally in space and time since all computations can be realized at each time step in the first (resp. second) forward computing unit 2100 (resp. 3100) and the first (resp. second) forward weights accordingly updated in the first (resp. second) forward memory unit 2101 (resp. 3101).

In a particular embodiment, the first (resp. second) forward computing unit 2100 (resp. 3100) computes the difference between the second signal S₂ (resp. seventh signal S₇) and the third signal S₃ (resp. fifth signal S₅) and multiplies this difference with the first signal S₁ (resp. second signal S₂) as well as with a step-size parameter or learning rate to obtain a weight correction. This weight correction is then added to the original first (resp. second) forward weight W₁ (resp. W₂) to obtain the updated first (resp. second) forward weight that is stored back in the first (resp. second) forward memory unit 2101 (resp. 3101).

The updating of the first (resp. second) set of feedback weights Q₁ (resp. Q₂) stored in the first (resp. second) feedback memory unit 2101 (resp. 3101) can be realized by the first (resp. second) feedback computing unit 2100 (resp. 3100). The update rule for the first (resp. second) feedback weight integrates the feedback signal S_{f} as well as the fourth signal S₄ (resp. sixth signal S₆) so as to provide an approximation of an inverse function of the first (resp. second) forward weights W₁ (resp. W₂). This learning is therefore also local in time and space.

In a particular embodiment, the first (resp. second) feedback computing unit 2100 (resp. 3100) computes the product between the feedback signal S_{f} provided by the first control unit 40 and the fourth signal S₄ (resp. sixth signal S₆), and adds the result to the original first (resp. second) set of feedback weights Q₁ (resp. Q₂) to obtain the updated first (resp. second) set of feedback weights which is stored back in the first (resp. second) feedback memory unit 2111 (resp. 3111).

The learning rules of both the forward and feedback weights can be adapted/modified according to the specific needs and use cases of the circuit.

The neural network circuit may comprise in addition to the first control unit 40, a second control unit for tracking and controlling particular activities of the network, such as for example the activation of a specific subset of neurons. This second control unit can be a controller individually connected to each respective neuron in the hidden layer(s) and output neuron(s) in the output layer of the network so as to be able to receive signals from each neuron and output neuron and send back a regulation signal to at least one of the different (first/second forward, feedback and central) computing units. Alternatively, this second control unit can be connected only to a specific subset of neurons in the neural network, for example to the neurons in the hidden layer(s). Other way of connecting the second control unit to the neurons can be considered according to the specific needs.

In addition, the second control unit can be configured for outputting signals containing information about the specific activation of certain subnetworks of the neural network during a training phase. Indeed, it is not rare that particular subnetworks are better suited for performing certain tasks than other subnetworks. Such features are particularly useful for allowing efficient continual learning of neural networks.

In a particular embodiment, the second control unit can be a PID controller individually connected to the central compartment of each respective neuron (or to the central compartment of a smaller subset of neurons) and configured to receive the second signals S₂ generated by these first central compartments. The second control unit can for example impose constraints on the number of activated neurons by sending regulations signals to each neurons based on the comparison between the total activity of the network at a given time (i.e. the sum of all second signals) and a stored target activity. More generally, a large variety of cost functions can be implemented in order, for example, to drive the network activity towards a target activity, to obtain specific patterns or to minimize the cross entropy. Any suitable cost function can be implemented according to the specific needs of a situation.

Other embodiments of the present invention may include additional control units connected to the central compartments of each respective neuron or to a particular subset of neurons in order to control several aspects of the neural activity.

The present neural network electronic circuit can implement a large variety of neural networks. The number of neurons in the input layer, the number of hidden layers, the number of neurons in each hidden layer, the number of output neurons in the output layer as well as the connections between the different layers and between neurons in a same layer can be determined so that the circuit may implement, for example: fully connected neural networks, deep neural networks, convolutional neural networks, autoencoder neural networks, generative adversarial networks, recurrent neural networks, LSTM networks, spiking neural networks, or any combinations of the mentioned networks.

1. A time-continuous neural network electronic circuit implemented on analog hardware with device mismatch, comprising,
an input layer;
at least one hidden layer, wherein a first hidden layer of the at least one hidden layer is operatively connected to the input layer;
an output layer, wherein the output layer is operatively connected to a hidden layer of the at least one hidden layer;
a first control unit operably connected to the at least one hidden layer and the output layer; and
wherein the at least one hidden layer comprises a plurality of neurons for processing at least one first signal which the first hidden layer is configured to receive from the input layer; and
wherein the output layer comprises at least one output neuron for processing at least one second signal which the output layer is configured to receive from the at least one hidden layer;
wherein, each respective neuron in the at least one hidden layer comprises,
(i) a first forward compartment configured for receiving and processing, in a first forward computing unit which first forward computing unit is comprised by the circuit, a) the first signal received from the input layer in case of a neuron in the first hidden layer or b) a second signal of the at least one second signal received from a hidden layer of the at least one hidden layer in case of a neuron in a hidden layer different from the first hidden layer, and for generating a third signal based on the first signal or based on the second signal and based on an associated first set of forward weights stored in a first forward memory unit which first forward memory unit is comprised by the circuit,
(ii) a first feedback compartment configured for receiving and processing, in a first feedback computing unit which first feedback computing unit is comprised by the circuit, a feedback signal received from the first control unit, and for generating a fourth signal based on the feedback signal and based on an associated first set of feedback weights stored in a first feedback memory unit which first feedback memory unit is comprised by the circuit,
(iii) a first central compartment connected to said first forward and first feedback compartments and configured for receiving and processing, in a first central computing unit which first central computing unit is comprised by the circuit, the third signal from the first forward compartment and the fourth signal from the first feedback compartment, and configured to generate a second signal based on the third and fourth signals;
and each output neuron in the output layer comprises,
(iv) a second forward compartment configured for receiving and processing, in a second forward computing unit which second forward computing unit is comprised by the circuit, a second signal of the at least one second signal from a neuron in the at least one hidden layer, and for generating a fifth signal based on the second signal and based on an associated second set of forward weights stored in a second forward memory unit which second forward memory unit is comprised by the circuit,
(v) a second feedback compartment configured for receiving and processing, in a second feedback computing unit which second feedback computing unit is comprised by the circuit, the feedback signal, and for generating a sixth signal based on the feedback signal and based on an associated second set of feedback weights stored in a second feedback memory unit which second feedback memory unit is comprised by the circuit,
(vi) a second central compartment connected to said second forward and second feedback compartments and configured for receiving and processing, in a second central computing unit which second central computing unit is comprised by the circuit, the fifth signal from the second forward compartment and the sixth signal from the second feedback compartment, and configured to generate a seventh signal based on the fifth and sixth signals;
and wherein the first control unit is connected to the output layer and configured to receive a network output signal from the output layer, based on the seventh signals of the second central compartment of the output neuron, and wherein said first control unit is further individually connected to the first feedback compartment of each respective neuron in the hidden layer and to the second feedback compartment of the output neuron in the output layer and is configured to generate the feedback signal based on a comparison between said network output signal and a stored target signal.

2. A circuit according to claim 1, wherein the first forward computing unit is configured to update the first set of forward weights based on the first, the second and the third signal, and wherein the second forward computing unit is configured to update the second set of forward weights based on the second, the fifth and the seventh signal.

3. A circuit according to claim 1, wherein the first feedback computing unit is configured to update the first set of feedback weights based on an approximation of an inverse of a function of the first set of forward weights and based on the feedback signal, and wherein the second feedback computing unit is configured to update the second set of feedback weights based on an approximation of an inverse of a function of the second set of forward weights and based on the feedback signal.

4. A circuit according to claim 1, wherein the first control unit is embodied as a proportional and/or integrative and/or derivative controller.

5. A circuit according to claim 4, wherein the first control unit is embodied as a neural network proportional and/or integrative and/or derivative controller.

6. A circuit according to claim 1, further comprising a second control unit individually connected to each respective neuron in the at least one hidden layer and to each output neuron in the output layer, the second control unit being configured to generate and send a control signal to the at least one neuron in the at least one hidden layer and to the at least one output neuron in the output layer so as to modify activation parameters of the neural network.

7. A circuit according to claim 6, wherein the control signal can be generated based on the second signal generated by the first central computing unit of the at least one neuron in the at least one hidden layer and/or based on the seventh signal generated by the second central computing unit of the at least one output neuron.

8. A circuit according to claim 6, wherein said second control unit is embodied as a proportional and/or integrative and/or derivative controller.

9. A circuit according to claim 1, comprising ‘n’ hidden layers, wherein ‘n’ is greater than two, and wherein the ‘n’ hidden layers are connected consecutively, and wherein the first hidden layer is operably connected to the input layer, and the ‘n^{th}’ hidden layer is operably connected to the output layer.
